(19) United States
(12) Patent Application Publication
(10) Pub. No.: US 2005/0234642 A1
(43) Pub. Date: Oct. 20, 2005

(54) Location responsive application development and system

(75) Inventor: Blaine H. Dolph, Western Springs, IL (US)

Correspondence Address: Robert V. Wilder;Attorney at Law, 4235 Kingsburg Drive, Round Rock, TX, 78681, US

(73) Assignee: International Business Machines Corporation, Armonk, NY (US)

(21) Appl. No.: 10/824,807

(22) Filed: Apr. 15, 2004

(51) Int. Cl. G01C 21/26

(52) U.S. Cl. 701/213; 342/357.08

(57) ABSTRACT

A method and implementing system are provided for enabling the use of predetermined geometric models and polygonal representations of geographic areas in developing GPS-related application programs. In an exemplary embodiment, a development process uses GPS streams of data and a set of rules or a syntax for referencing predetermined shapes in defining various geographical areas of interest. Different areas are defined in terms of polygons and named for storage in a database for retrieval in the development of programs related to the areas. GPS data streams are used to locate or define key points in the area polygons and these points are related to GPS signals received by an application device to enable processing and development of various applications which depend upon receiver device location.

### FIELD OF THE INVENTION

The present invention relates generally to information processing systems and more particularly to a methodology and implementation for enabling global positioning system (GPS) application development.

### BACKGROUND OF THE INVENTION

Global Positioning System or GPS is a technology for assigning a geographic location to a device on the earth. A GPS receiver on the surface of the earth communicates with a set of GPS satellites orbiting the earth to derive an accurate position. GPS receivers have become very inexpensive and are being designed into personal digital assistant (PDA) devices as well as laptop computers, cell phones, digital cameras and other wireless devices.

Notwithstanding the increasing popularity of GPS receivers for more and more applications, there is no standard development environment or programming syntax to interface between an incoming GPS data stream and the thousands of applications that are being written to run on the various wireless devices.

Thus, there is a need for an improved methodology and system for providing a standard environment that allows a GPS applications to be built and developed in a more expedient manner.

### SUMMARY OF THE INVENTION

A method and implementing system are provided for enabling the use of predetermined geometric models and polygonal representations of geographic areas in developing GPS-related application programs. In an exemplary embodiment, a development process uses GPS streams of data and a set of rules or a syntax for referencing predetermined shapes in defining various geographical areas of interest. Different areas are defined in terms of polygons and named for storage in a database for retrieval in the development of programs related to the areas. GPS data streams are used to locate or define key points in the area polygons and these points are related to GPS signals received by an application device to enable processing and development of various applications which depend upon receiver device location.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration showing several of the components of the disclosed GPS-related application development system;

FIG. 2 is an illustration of a PDA device which may be used in an exemplary embodiment of the present invention;

FIG. 3 is a block diagram illustrating several of the components within an application device;

FIG. 4 is an exemplary layout of a zoo which is useful in explaining an operation of the present invention;

FIG. 5 is an illustration of a screen display used in connection with the present invention;

FIG. 6 is an illustration of another screen display which uses the present invention in developing a user application;

FIG. 7 is an illustration showing an exemplary syntax which may be implemented in practicing the present invention; and

FIG. 8 is a flow chart showing an operational processing sequence in an exemplary implementation of the present invention.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention. Although the present invention is herein disclosed using a wireless personal computer in the example, it is understood that the invention applies as well to any GPS responsive programmable device.

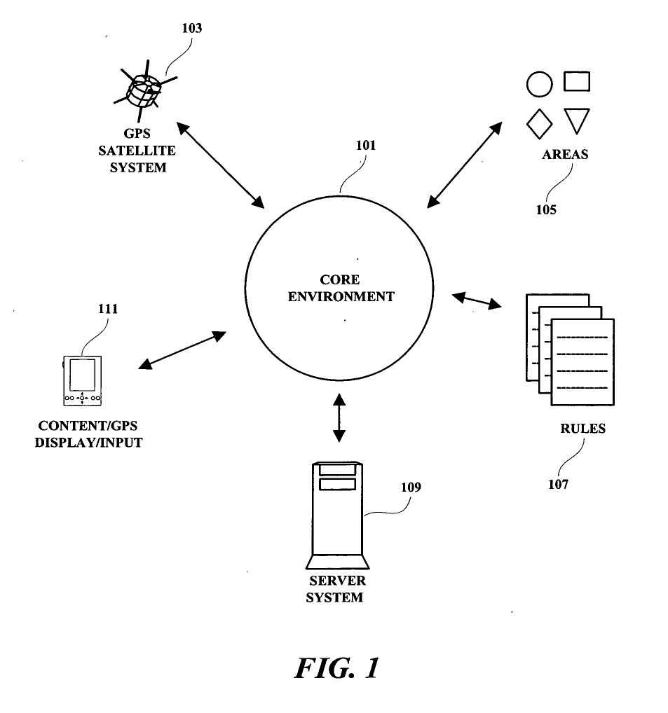

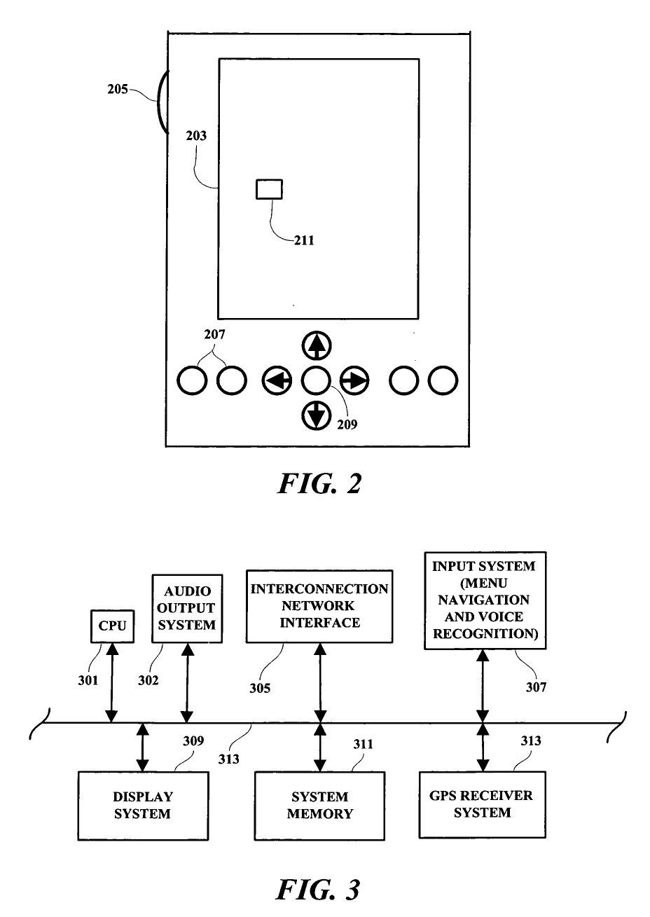

As shown in FIG. 1, an exemplary location responsive application development system includes a core environment 101 which interconnects a GPS satellite system 103, a library of predetermined standard shapes 105, a rules or syntax database 107, one or more accessible server systems 109 and one or more GPS-responsive application devices 111. The application device 111 in the present example includes a GPS receiver and processing circuitry which may be embodied in a personal digital assistant (PDA) device, a wireless personal or palm computer, a “smart” cell phone or other similar wireless devices. The system components co-relate to each other to provide an environment in which a user is enabled to quickly and easily develop many GPS-related applications. The various component functions of the system may also be embodied in software which may be stored locally in the application devices 111 or in local or remote server systems 109. In FIG. 2, several of the key elements of the application device 111 are illustrated. As shown, an exemplary application device 201 includes an ON-OFF/Volume switch 205, a display screen 203, various control buttons 207 and a navigational switch array 209 which is used in moving a cursor or highlighted area 211 on the display screen 203. FIG. 3 is a block diagram of several of the electronic systems within the application device 201. As shown, a CPU 301 is connected to a main bus 313. Also connected to the main bus 313 are an audio output system 302, an interconnection network interface 305 and an input system 307 which may include menu, navigation and voice recognition circuitry. Also connected to the main bus are a display system 309, a system memory 311 and a GPS receiver system 313. The GPS receiver 313 is operable for receiving satellite signals from a plurality of satellites and determining a location of the receiver on the surface of the earth. The location information is then processed to develop the receiver location in terms of latitude, longitude and altitude relative to sea level, or X, Y and Z coordinates. This information is then further processed, as is hereinafter explained, in developing a GPS-related application which may be executed on the application device 201. The application device is also used to develop the GPS-related application by enabling a user to identify specific points and areas located on the surface of the earth to be used in triggering predetermined audio output messages to a user who is carrying the application device while moving through a geographic area of interest.

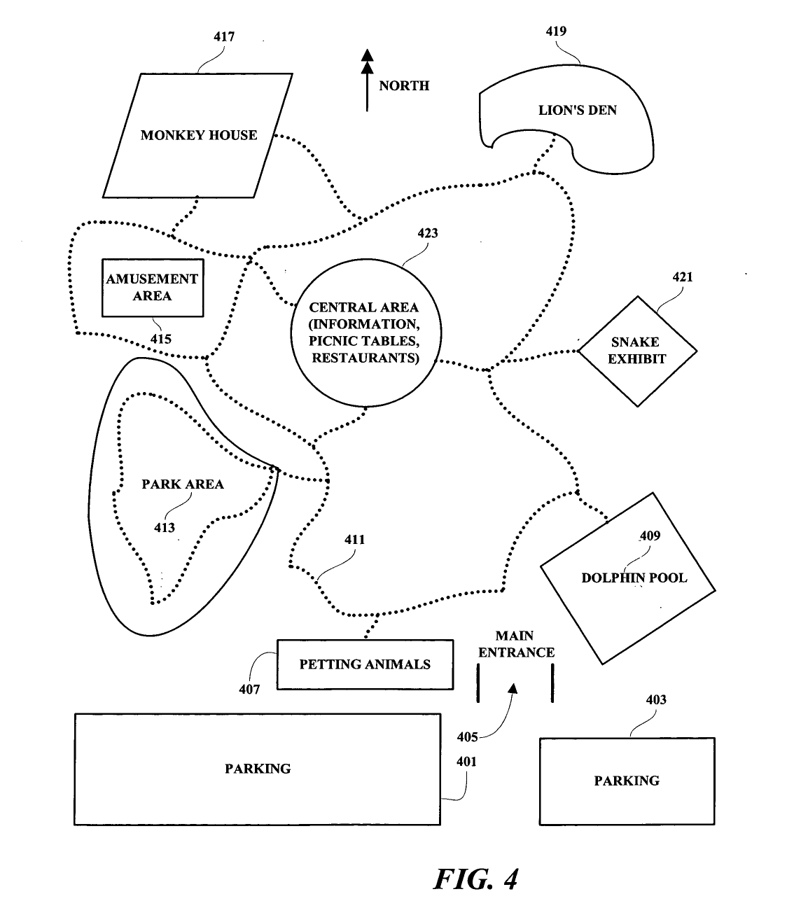

As shown in FIG. 4, an exemplary area of interest to a user may be a zoo exhibit. In the example, the zoo includes several parking areas 401 and 403 and a main entrance 405. The zoo includes a petting animal area 407, a park area 413, an amusement area 415, a monkey house 417, a lions den 413 a snake exhibit 421 and a dolphin pool 409. In the example, all of the areas are connected to a central area 423 and interconnected to each other by a path 411. The central area 423 includes an information booth, picnic tables and a restaurant in the example. The application device is programmed to provide information to a user concerning the special features and characteristics of the zoo relative to the location of the user and the application device within the zoo.

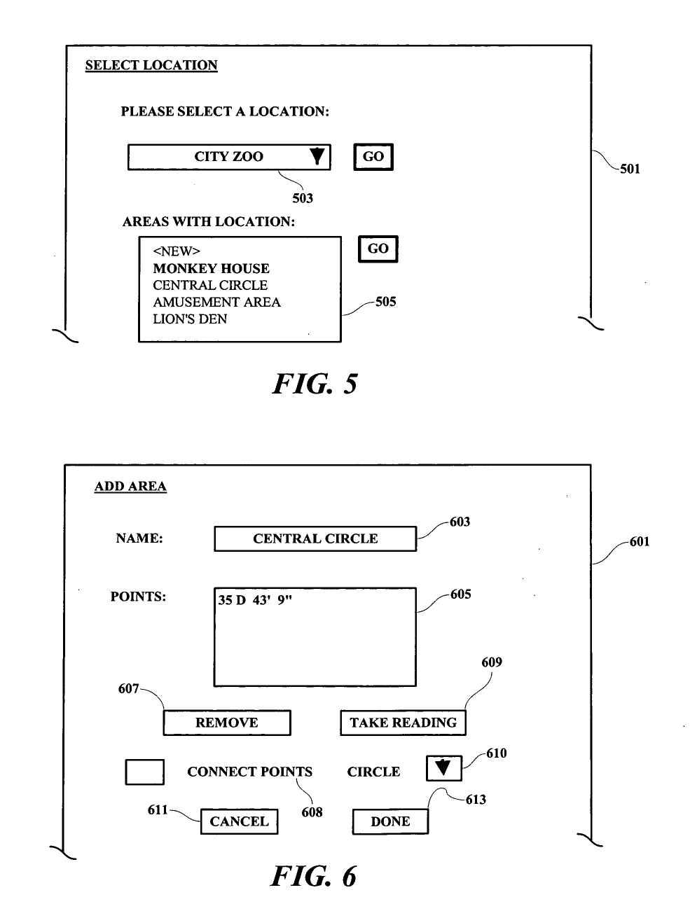

For example, as shown in FIG. 5, a display screen 501 of the application device displays various locations 503 in which the user may be interested. A more detailed menu is programmed to display various specific locations 505 within the general location 503 selected by the user. Once a specific location 505 has been selected by a user, the application device is programmed to provide further information details regarding the specific attraction. For example, the application device may display and/or provide audio or voiced output with specific information concerning the selected attraction. This information may include directions to the selected attraction from the current location of the application device by using the GPS receiver system in combination with a program written specifically for the zoo layout as is hereinafter described. If the snake exhibit were chosen for example, the application device may also display and/or announce the number of snakes on exhibit, the type of snakes and other interesting facts relating to the snakes in the exhibit. This can be further tied to the location of the application device within a matter of feet so as to provide information to a user regarding an exhibit right next to where the user is standing, even within an exhibit. Thus, in a pro-active mode, the application device may be used to provide information to a user pursuant to specific user input which is determined by user selections 209 from menus presented on the display screen. In a passive mode, the application device is programmed to provide audio and/or video information to a user based solely on the location of the application device with the GPS receiver. As the user moves among the various specific areas, pre-defined boundaries are crossed and the application device compares the present location of the application device with the pre-defined boundaries, and retrieves relevant information which is automatically announced and/or displayed to the user. For example, as a user moves out of the snake exhibit 421, the application device would announce and/or display directions to the other exhibits in the area, i.e. the Lion's Den 419 and the Dolphin Pool 409 and also the Central Area 423.

To develop the user application described above, as well as other applications relating to physical location on the surface of the earth, a GPS application development environment is provided. In the development mode, the same menu as shown in FIG. 5 may be used in order to develop areas and boundaries (105) which are used as a grid or reference for the GPS-sensitive application device. In developing the separate areas within an attraction, a developer would select an area, provide a name for the area for retrieval purposes and then develop and assign a geometric shape to the area which would trace the actual boundaries of the area on the surface of the earth. In an example, several standard geometric shapes are generated once several points relative to such shapes are input by a developer. For example, when a developer inputs a center point and a radius, a circle is generated such as area 423. The boundary or perimeter points, and/or an algorithm for generating a circle from the known points, of the area 423, along with the name of the area, i.e. “Central Area”, is stored in a database and is retrieved by a programmer in linking area-related information in developing the application program for the zoo. Other standard shapes are also available for reference including a square, a rectangle, a triangle, a parallelogram and others. In addition to the standard shapes, custom shapes may also be created to define specific areas of interest in the zoo.

Custom shapes are created by the development program when a developer stands on and “enters” a location by pushing an “enter” button, such as button 209, while running the application development program on the application device. Whenever a point is so identified, the coordinates of that point are stored and the related shape of that area is developed using the points identified and input by the user. For example, as shown in FIG. 6, when an “Add Area” menu is selected and displayed on the display screen 601, in defining the Central Circle 603, a developer will select a “CIRCLE” 610 as the shape to be developed. The developer will then go to a point on the surface of the earth which the developer wishes to have as the Center of the circle, highlight the TAKE READING selection 609 and then hit the DONE button 613, i.e. press the ENTER button 209 when the DONE selection 613 is highlighted. The GPS receiver will then establish the coordinates of the point where the GPS receiver application device was located, and display the location of the circle 605. The developer may then CANCEL 611 and/or or change the defined area associated with the CENTRAL AREA 603. Similarly, other predefined shapes may be selected 610, sized and located using the above procedure. If an area is a polygon but not one of the predefined area shapes, the polygon may still be sized and defined by taking readings at various perimeter points on the ground and selecting CONNECT POINTS 608 when all of the transition points have been entered. The development program will then connect all of the entered points and assign a name to the shape for subsequent reference and retrieval in linking information output to the relative actual position of a user within a defined grid made up of a plurality of predefined shaped areas.

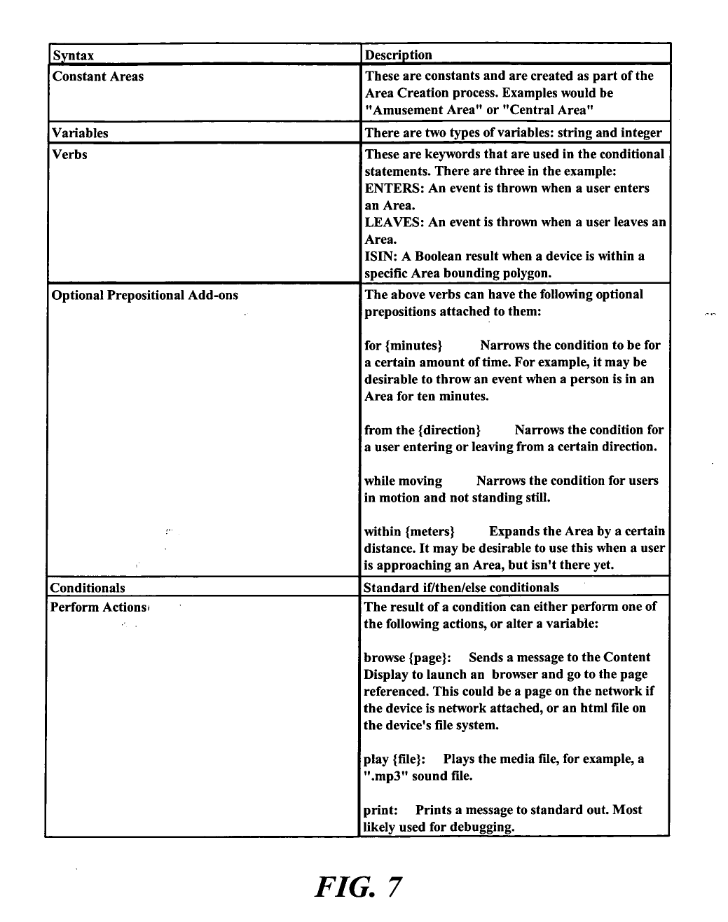

FIG. 7 shows a partial listing of exemplary rules or syntax for the GPS-related application program development coding. As illustrated, Constant Areas are defined as well as Variables, Verbs and optional prepositional add-ons. The add-ons include support for enabling a duration attribute “for {minutes}”, as well as specifications for direction, moving and proximity references. Standard “if/then/else” conditional statements are also provided along with various actions that may be specified such as “browse” (using network interface 305), “play” (for example sound files) and “print” to display or print to an output.

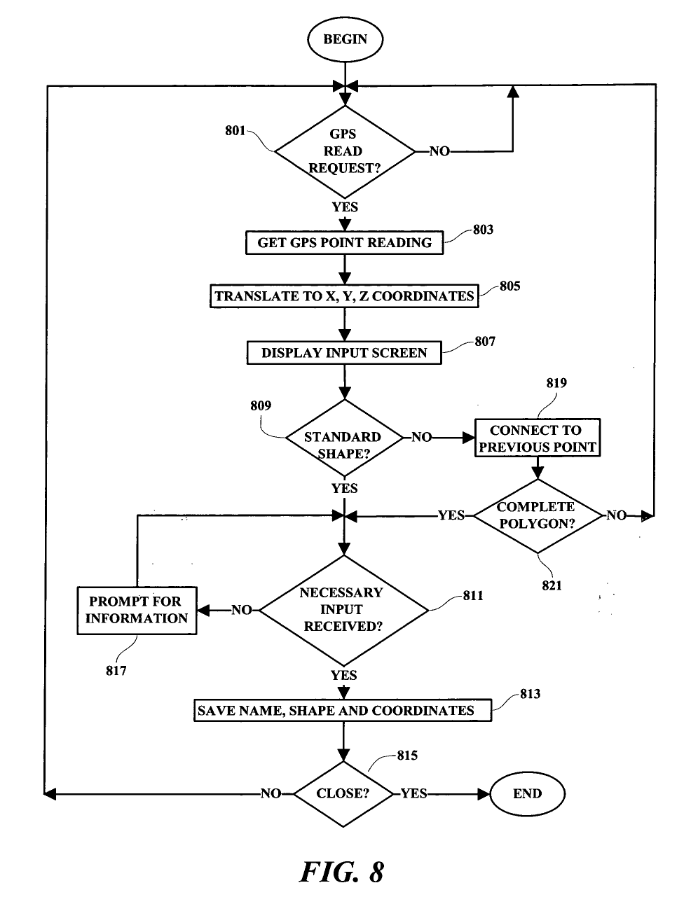

FIG. 8 illustrates an exemplary flow sequence when a developer is identifying and establishing points of a predetermined shape or other polygon. As shown, when a GPS read request is received 801, a GPS point reading is taken 803 for the point at which the GPS receiver/application device is located. The GPS signals are converted to X, Y, Z coordinates 805 and the point is displayed 807 on the display screen. If a developer selects to use the identified point in defining a standard or predefined shape 809, the program will determine if all of the necessary input information to define the shape has been input by the developer 811. Such information would include, for example, the name of the shape and the center point and diameter for a circle, or the name and three points for a triangle, etc. If sufficient information has not been received, then a prompt is displayed to the developer to input the necessary information to define the shape. When sufficient information has been received, the name, shape and coordinates of the defined shape are saved 813 for access by an application program. If the developer has selected to close the process 815 the process is ended. Otherwise, the process will return to await another GPS read request from the developer.

If the developer wishes to define a shape that is not a standard or predefines shape 809, then the last identified point is connected to the previous point 819. If the developer then wishes to complete the polygon 821 (by selecting 608, FIG. 6), then the polygon is completed and saved 813. If the developer wishes to input more boundary points, then the polygon is not completed 821 and the process returns to await the input of another GPS read request 801.

After the shapes have been identified, located and saved, the application program may be written to access and play visual and sound files depending upon the location of the GPS receiver/application device within, for example, the zoo as shown in FIG. 4. Several examples of this application programming based on the disclosed application development environment are disclosed below:

```
if enters lionsden from the north then
      browse http://lionsdennorth.html
endif
if leaves amusementarea then
      play amusementarea.mp3
      amusementareacount = amusementareacount + 1
      print “in amusement area + amusementareacount “times”
endif
if enters dolphinpool within 10 then
      if dolphinpoolcount > 1
          print “You are close to the Dolphin Pool again.
          Turn left if you would like to visit the Dolphin
          Pool again”
      endif
endif
```

Code such as that illustrated in the above examples are used at development time for developers. This syntax uses simple English-type commands for any developer to build applications. A runtime component also interprets the code, constantly queries the GPS location and throws the events to any conditions that are met. The coordinates are used to determine if the user is in any of the defined bounded areas.

The system is also enabled to be connected through an interconnection network interface 305 to a local or remote server 109 to download and play additional information which may be extensive and more detailed than the information stored locally on the application device. The application program may also include a menu by which the user may select a particular platform on which the user is operating. With this feature, the zoo application, for example, may be downloaded from a network server to any particular device a user is carrying. For example, the user application may be run on a Browser on a personal computer (PC), a Pocket Browser such as Internet Explorer™ (IE), a Visual Basic™ (VB) Application or a GPS cell phone using a Java2™ Micro Edition (J2ME).

The method and apparatus of the present invention has been described in connection with a preferred embodiment as disclosed herein. The disclosed methodology may be implemented in a wide range of sequences to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

1. A method for developing GPS-related user applications, said method comprising:
acquiring a GPS reading for a location at which a GPS receiver is located;
determining a desired geometric shape to be related to said GPS reading; and
applying said geometric shape to said GPS reading for defining an area having said geometric shape, said area having a selectable relationship to said GPS reading.

2. The method as set forth in claim 1 wherein said geometric shape is determined by:
acquiring a plurality of said GPS readings;
converting said GPS readings to location points; and
connecting said location points together to provide said geometric shape.

3. The method as set forth in claim 1 and further including:
storing in memory a plurality of algorithms for generating said geometric shapes; and
selecting one of said geometric shapes for said applying.

4. The method as set forth in claim 3 wherein one of said plurality of geometric shapes is a circle.

5. The method as set forth in claim 4 wherein said GPS reading is a center point for said circle.

6. The method as set forth in claim 5 wherein a diameter related value for said circle is input by a user.

7. The method as set forth in claim 5 wherein a diameter related value for said circle is input by taking GPS readings for two locations, said diameter being defined by a line joining said two locations.

8. The method as set forth in claim 3 wherein one of said geometric shapes is a polygon.

9. The method as set forth in claim 3 wherein one of said geometric shapes is a triangle.

10. The method as set forth in claim 3 wherein one of said geometric shapes is a square.

11. The method as set forth in claim 1 wherein said method is accomplished by an execution of an application development program, said application development program including code for creating predetermined areas.

12. The method as set forth in claim 1 wherein said method is accomplished by an execution of an application development program, said application development program including code for defining string and integer variables.

13. The method as set forth in claim 1 wherein said method is accomplished by an execution of an application development program, said application development program including code for defining verbs useful in writing said user applications, said verbs including keywords used in conditional statements.

14. The method as set forth in claim 13 wherein said verbs include a keyword for triggering a throwing of an event when a user enters said defined area.

15. The method as set forth in claim 13 wherein said verbs include a keyword for triggering a throwing of an event when a user leaves said defined area.

16. The method as set forth in claim 13 wherein said verbs include a keyword for triggering a throwing of an event when a user is presently within said defined area.

17. The method as set forth in claim 13 wherein said application development program further includes code for defining prepositions which may be attached to said verbs.

18. The method as set forth in claim 17 wherein said prepositions include code for narrowing a referenced condition to be for a specified amount of time.

19. The method as set forth in claim 17 wherein said prepositions include code for narrowing a condition to when a user is entering or leaving said defined area from a certain direction.

20. The method as set forth in claim 17 wherein said prepositions include code for narrowing a referenced condition to apply only to a user in movement.

21. The method as set forth in claim 17 wherein said prepositions include code for expanding a periphery of one of said areas by a selectable amount.

22. The method as set forth in claim 1 wherein said method is accomplished by an execution of an application development program, said application development program including code for accomplishing a predetermined processing action.

23. The method as set forth in claim 22 wherein said predetermined processing action is a launching of a browser application.

24. The method as set forth in claim 22 wherein said predetermined processing action is a playing of an audio file.

25. The method as set forth in claim 22 wherein said predetermined processing action is a printing of a message.

26. A GPS-related user application device comprising: a GPS receiver selectively operable for obtaining present location GPS readings for locations at which said device is located;
bus means connected to said GPS receiver; and
processing means connected to said bus means, said application device being selectively operable for determining a relationship between said present location readings and predefined stored areas, and providing an output related to said relationship.

27. The device as set forth in claim 26 wherein said output is a playing of an audio file on said device.

28. The device as set forth in claim 27 wherein said audio file is an informational audio file operable to verbalize information to said user regarding a present location of said user relative to one or more of said areas.

29. The device as set forth in claim 27 wherein said audio file is a music file.

30. The device as set forth in claim 26 and further including a display device coupled to said bus means and said output is an informational display presented on said display device.

31. The device as set forth in claim 26 wherein said output is effective to cause a printing of a file.

32. The device as set forth in claim 26 wherein said output is effective to cause an opening of a browser application on said device.

33. A medium programmed to provide operating signals when said medium is read by a compatible reading device, said operating signals being effective for enabling development of GPS-related user applications, said operating signals being further effective for:
acquiring a GPS reading for a location at which a GPS receiver is located;
determining a desired geometric shape to be related to said GPS reading; and
applying said geometric shape to said GPS reading for defining an area having said geometric shape, said area having a selectable relationship to said GPS reading.

34. A medium programmed to provide operating signals when said medium is read by a compatible reading device in an application device, said operating signals being effective for enabling location responsive programmed output on said application device, said operating signals being further effective for:
determining a present location of said application device;
relating said present location to one or more predefined geometrically shaped areas stored in memory; and
causing an output from said application device depending upon said location of said application device relative to said predefined geometrically shaped areas.
